(19) United States
(12) Patent Application Publication
(10) Pub. No.: US 2010/0117896 A1
(43) Pub. Date: May 13, 2010

(54) Global Satellite Positioning System Gunfire Detection System

(76) Inventor: Charles CHU, Banciao City (TW)

Correspondence Address: Muncy, Geissler, Olds & Lowe, PLLC, P.O. BOX 1364, FAIRFAX, VA, 22038-1364, US

(21) Appl. No.: 12/340,001

(22) Filed: Dec. 19, 2008

(30) Foreign Application Priority Data
Nov. 7, 2008 (TW) 097143067

(51) Int. Cl. G01S 1/00

(52) U.S. Cl. 342/357.07

(57) ABSTRACT

A GPS gunfire detection system, which includes a plurality of detectors, each of which is provided with several microphones, disposed on an object, and a GPS tracker is located close to the object. The detectors detect circumstances regarding the object being hit by bullets and collect gunshot sounds, the detected information and gunshot sounds being transmitted to the GPS tracker. A GPS receiving circuit of the GPS tracker receives geographic positioning satellite coordinate signals, which are matched with an internal prestored geographic data base to obtain the object position, which is then transmitted to a microprocessor of the GPS tracker, from where information on the object position, circumstances surrounding the gunfire and gunshot sounds are transmitted to a remote server using a signal transmission circuit to enable calculating the location of the gunfire and notifying relevant authorities, thereby enabling speeding up emergency aid to personnel and rescue of casualties.

### BACKGROUND OF THE INVENTION

(a) Field of the Invention

The present invention relates to a GPS (Global Satellite Positioning System) gunfire detection system, and more particularly to a GPS tracker device able to transmit circumstances regarding an object being hit by bullets and gunshot information to a remote server to enable location of the gunfire to be calculated, and notify rescue units.

(b) Description of the Prior Art

Since development of the global satellite positioning system (GPS) by the American Military, and after the government made the GPS open to public use, there has been continuous advancement in related technology and technical products, including application in various industries and at various levels, greatly increasing the standard of living of people and improving convenience in daily life, even accelerating notification of emergencies and the speed of medical rescue.

The global satellite positioning system consists of several space satellites, ground control stations and GPS receivers. Currently, there are 24 space satellites orbiting the Earth, and each of the space satellites equally maintain transmission of geographic position satellite coordinate signals carrying satellite orbit data and time for every type of terrestrial GPS receiver to receive. The ground control stations are responsible for tracing and controlling operation of each of the space satellites, as well as being responsible for correcting and maintaining each of the space satellites, thereby enabling normal continual transmission of each type of parameter data to the GPS receivers.

However, satellite navigators of the prior art are only able to indicate current position, route direction and neighboring buildings, and are not used to record circumstances of an object (such as: a bus, an army vehicle, a police vehicle, bulletproof clothing, and so on) being hit by bullets and calculate location of the gunfire, resulting in the inability to effectively speed up the rescue of personnel, and thus limiting use range thereof. Hence, there is still a need for developmental design of other uses for satellite navigators.

### SUMMARY OF THE INVENTION

Hence, in light of the shortcomings of the aforementioned prior art, the inventor of the present invention, having accumulated knowhow and manufacturing experience of a diverse range of GPS (Global Satellite Positioning System) products, attentively researched various methods to resolve the shortcomings, which, following continuous research and improvements, culminated in the design of a completely new GPS gunfire detection system of the present invention.

One objective of the present invention is to provide a GPS gunfire detection system able to transmit circumstances regarding an object being hit by bullets and gunshot information to a remote server to enable location of the gunfire to be calculated, and notify relevant authorities, and thereby speed up emergency aid to personnel and rescue of casualties.

According to the aforementioned objective, the GPS gunfire detection system of the present invention comprises a plurality of detectors disposed on an object (such as: a bus, an army vehicle, a police vehicle, bulletproof clothing, and so on), and each of the detectors is provided with several microphones. A GPS tracker is located close to a position on the object, and the GPS tracker is provided with a GPS receiving circuit, a microprocessor and a signal receiving/transmission circuit. Accordingly, the detectors can detect circumstances regarding the object being hit by bullets and collect gunshot sounds, and the detected information and gunshot sounds are transmitted to the microprocessor of the GPS tracker. The GPS receiving circuit of the GPS tracker receives geographic positioning satellite coordinate signals, after which the geographic positioning satellite coordinate signals are matched with an internal prestored geographic data base to obtain the position of the object, whereupon the position is transmitted to the microprocessor. When in use, the microprocessor transmits information on the position of the object, circumstances regarding being hit by bullets and gunshot information to a remote server using the signal transmission circuit to enable recording the gunshot sounds in order to calculate the location of the gunfire and notify relevant authorities, thereby enabling speeding up emergency aid to personnel and rescue of casualties.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a circuit block diagram of a GPS gunfire detection system according to the present invention.

FIG. 2 is a schematic view depicting the GPS gunfire detection system of the present invention in use.

FIG. 3 is a circuit block diagram of another embodiment of the GPS gunfire detection system according to the present invention.

FIG. 4 is an operational flow chart of a remote server of the GPS gunfire detection system according to the present invention.

### DETAILED DESCRIPTION OF THE PREFERRED EMBODIMENTS

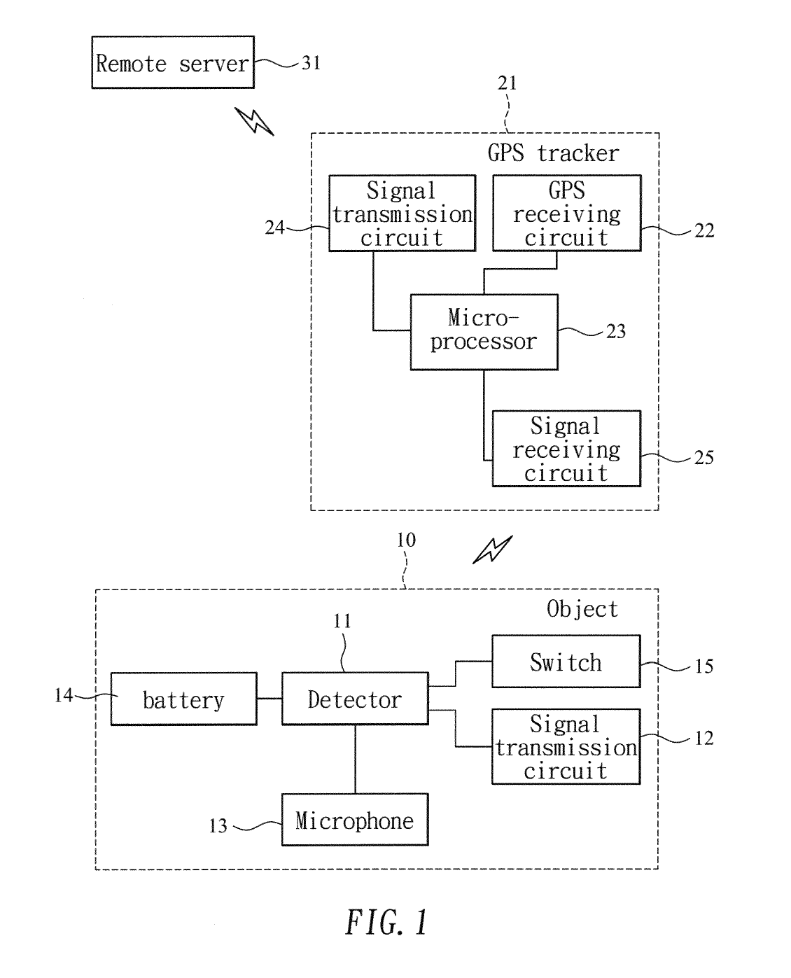

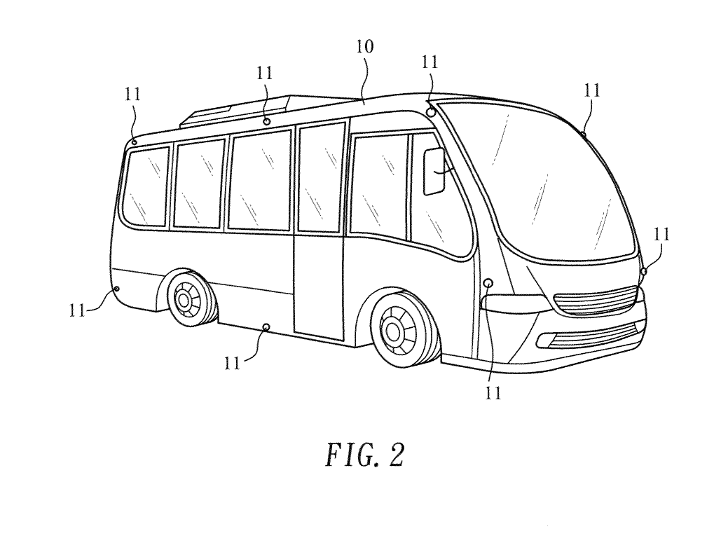

The present invention relates to a GPS gunfire detection system. Referring to FIGS. 1 and 2, which show a GPS (Global Satellite Positioning System) gunfire detection system of the present invention, wherein a plurality of detectors 11 and signal transmission circuits 12 are disposed on selected areas of an object 10 (such as: a bus, an army vehicle, a police vehicle, bulletproof clothing, and so on), and each of the detectors 11 is provided with a number of microphones 13 to enable the collection of gunfire sounds. A GPS tracker 21 is located close to a position on the object 10, and the GPS tracker 21 is provided with a GPS receiving circuit 22, a microprocessor 23, a signal transmission circuit 24 and a signal receiving circuit 25. The detectors 11 on the object 10 are connected to the signal transmission circuits 12, the detectors 11 enable detecting circumstances regarding the object 10 being hit by bullets, and the microphones 13 are used to collect gunshot sounds. Moreover, detected information and the collected gunshot sounds are transmitted to the microprocessor 23 of the GPS tracker 21 using the signal transmission circuits 12.

The microprocessor 23 of the GPS tracker 21 is separately connected to the GPS receiving circuit 22, the signal transmission circuit 24 and the signal receiving circuit 25. Accordingly, the GPS receiving circuit 22 of the GPS tracker 21 receives geographic positioning satellite coordinate signals, after which the geographic positioning satellite coordinate signals are matched with an internal prestored geographic data base to obtain the position of the object 10, whereupon the position is transmitted to the microprocessor 23.

According to the assembly of the aforementioned components, when in use, the microprocessor 23 obtains the position of the object 10 from the GPS receiving circuit 22, and obtains information on the circumstances regarding the object 10 being hit by bullets and gunshot sounds from the detectors 11 on the object 10, whereupon the information is transmitted to a remote server 31 using the signal transmission circuit 24. At which time, the remote server 31 records the gunshot sounds, and then calculates the location of the gunfire from the gunshot sounds, whereupon relevant authorities are notified of the position of the object 10, circumstances regarding the object 10 being hit by bullets and location of the gunshot sounds, thereby speeding up emergency aid to personnel and rescue of casualties.

Referring again to FIGS. 1 and 2, the GPS tracker 21 can be installed to user firearms or army vehicles, and can be effectively applied in areas where war has broken out. Moreover, the GPS tracker 21 is not a fixed type device, is low in price, easily installed and extremely convenient to use.

Referring again to FIGS. 1 and 2, the signal transmission circuits 12 of the object 10 can be connected to the signal receiving circuit 25 of the GPS tracker 21 through wired means, thereby enabling the signal transmission circuits 12 of the object 10 to transmit detector information from the detectors 11 to the microprocessor 23 of the GPS tracker 21 using the signal receiving circuit 25 through wired transmission means.

Referring again to FIGS. 1 and 2, the signal transmission circuits 12 of the object 10 can be connected to the signal receiving circuit 25 of the GPS tracker 21 through wireless means, thereby enabling the signal transmission circuits 12 of the object 10 to transmit detector information from the detectors 11 to the microprocessor 23 of the GPS tracker 21 using the signal receiving circuit 25 through wireless transmission means (such as: using RF (radio frequency) signals).

Referring again to FIGS. 1 and 2, a battery 14 is located within the object 10, and the battery 14 is connected to the detectors 11, thereby enabling electric power to be supplied to the detectors 11.

Referring again to FIGS. 1 and 2, the battery 14 can be a rechargeable battery, which is connected to a solar panel (not shown in the drawings) located on the object 10, thereby enabling electric power converted from solar energy received by the solar panel to charge the battery 14, thus enabling the battery 14 to maintain a fully charged state; or a battery charger can be used to charge the battery 14 and enable the battery 14 to maintain a fully charged state. Accordingly, electric power can be supplied to the detectors 11 for long periods of time.

Referring again to FIGS. 1 and 2, a switch 15 is located on each of the detectors 11, ends of the switches 15 are respectively connected to the detectors 11, and other ends are respectively connected to the battery 14. When using the object 10, the switches 15 are opened to effect a current conducting state (ON), thereby enabling the battery 14 to supply power to the detectors 11. When the object 10 is not being used, the switches 15 can be closed to enable an off-state, thereby causing the battery 14 to stop supplying power to the detectors 11. Accordingly, when not in use, the switches 15 can be closed, thereby achieving a power saving function.

Referring again to FIGS. 1 and 2, the GPS receiving circuit 22 can use GPS, A-GPS (Assisted Global Satellite Positioning System) or GPSone (GPS One, Global Satellite Positioning System One) satellite positioning technology, and the GPS information, including a combination of circumstances related to the object 10, such as time, position, altitude and speed, along with collected gunshot sounds are transmitted to the remote server 31.

Referring again to FIGS. 1 and 2, communication media of the signal transmission circuit 24 includes various kinds of wireless communication, such as: RF (Radio Frequency), GSM (Global System for Mobile Communications), GPRS (General Packet Radio Services), CDMA (Code Division Multiple Access), WiMAX WiFi (Worldwide Interoperability for Microwave Access Wireless Fidelity) or satellite to satellite communication.

Referring again to FIGS. 1 and 2, when the GPS signal is weak, then the microprocessor 23 can control the signal receiving circuit 25 to replace the GPS positioning signal with a GSM or CDMA base station positioning signal LBS (Location Based Service)/GPSone (GPS One), or a function that automatically records the last time and position is used to record the position of the object 10.

Referring again to FIGS. 1 and 2, when the detectors 11 have not detected that the object 10 has been hit by bullets within a period of time, then together with the signal transmission circuit 12, they are directed to enter a sleep mode, thereby achieving a power saving objective.

Referring again to FIGS. 1 and 2, the remote server 31 can computationally deduce location of the gunfire according to the position of the object 10 and volume of the recorded gunshot sounds, and is moreover able to determine whether the gunshot sounds were from a single shot, fixed point continuous gunfire or moving continuous gunfire according to the quality of the gunshot sounds.

Referring again to FIGS. 1 and 2, when the object 10 is a bus, then the microphones 13 can be installed to the front, rear, left and right sides of the bus to increase the volume of sound samples (as depicted in FIG. 2). If the GPS tracker 21 is of small size, then one microphone 13 can be used for input.

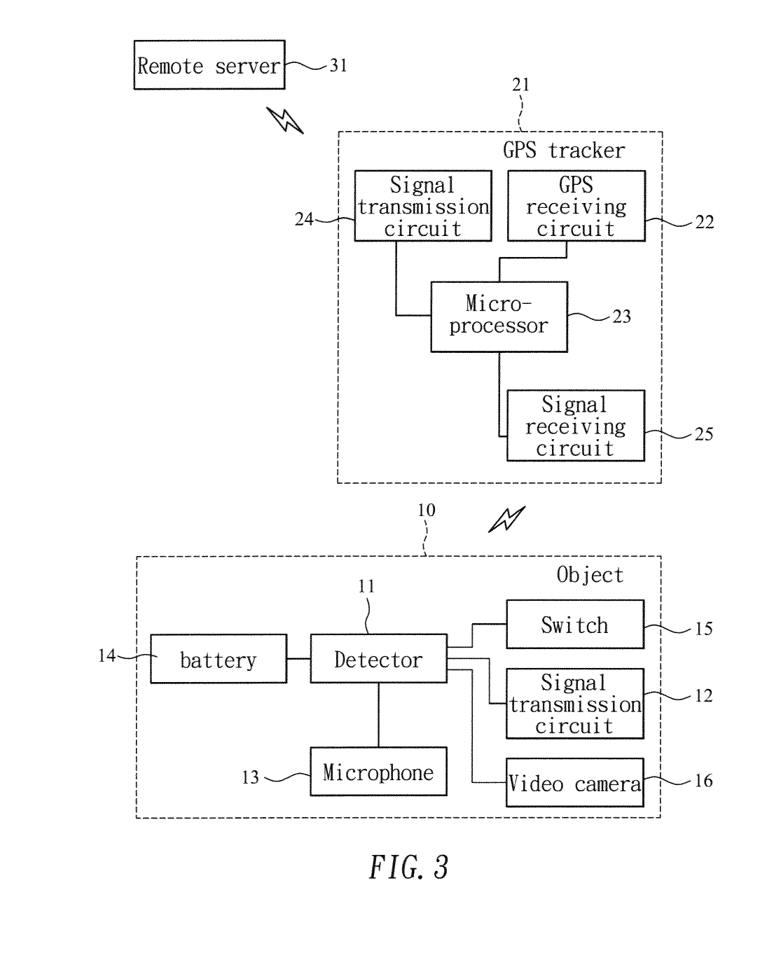

Referring to FIG. 3, which shows another embodiment of the present invention, wherein a video camera 16 is located on each of the detectors 11, thus, after the microphones 13 detect gunshot sounds, then the detectors 11 actuate the video cameras 16 to implement video recording for a period of time, after which the signal transmission circuits 12 transmit the information from recorded video footage to the microprocessor 23 of the GPS tracker 21, whereupon the microprocessor 23 transmits the information to the remote server 31 using the signal transmission circuit 24, thereby aiding the remote server 31 in interpreting the circumstances of the gunfire.

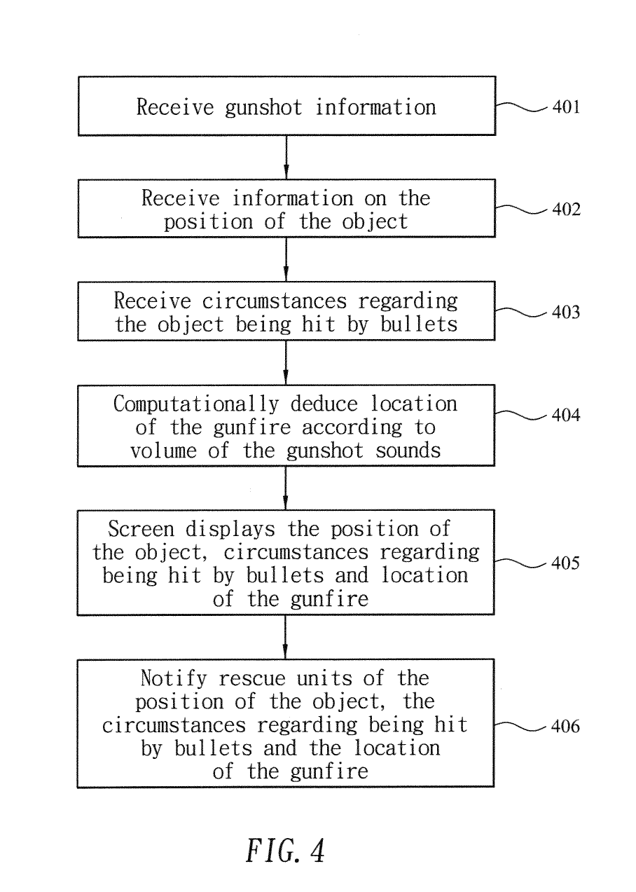

Referring to FIG. 3 and FIG. 4, when the remote server 31 receives information from the GPS tracker 21, the following processing steps are carried out:

(401) First, receive gunshot information collected by the microphones 13;

(402) Receive information on the position of the object 10;

(403) Receive circumstances regarding the object 10 being hit by bullets;

(404) Computationally deduce location of the gunfire according to volume of the gunshot sounds (the other embodiment of the present invention enables determining whether the gunshot is a single shot, fixed point continuous gunfire or moving continuous gunfire according to the quality of the gunshot sounds);

(405) Use a screen to display the position of the object 10, circumstances regarding being hit by bullets and location of the gunfire for related personnel to refer to or enable carrying out further processing;

(406) Notify rescue units of the position of the object 10, the circumstances regarding being hit by bullets and the location of the gunfire to help in the rescue by the rescue units, and speed up emergency aid to personnel and rescue of casualties, thereby reducing personal casualties.

In conclusion, the GPS gunfire detection system of the present invention is assuredly provided with an innovative structure not found in the prior art. Moreover, no similar products have been seen in any publication or in the market; the present invention is thus provided with undoubted originality. In addition, the present invention is provided with unique characteristics and functionality that are without comparison in the prior art. Hence, the incomparable advancement of the present invention clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A GPS (Global Satellite Positioning System) gunfire detection system, comprising:
a plurality of detectors and signal transmission circuits disposed on selected areas of an object, and each of the detectors is provided with a number of microphones to enable the collection of gunfire sounds, the detectors are connected to the signal transmission circuits, the detectors enable detecting circumstances regarding the object being hit by bullets, and the microphones are used to collect gunshot sounds, detected information and collected gunshot sounds are transmitted to a microprocessor of a GPS tracker using the signal transmission circuits;
the GPS tracker located close to a position on the object, and the GPS tracker is provided with a GPS receiving circuit, the microprocessor, a signal transmission circuit and a signal receiving circuit, the microprocessor is separately connected to the GPS receiving circuit, the signal transmission circuit and the signal receiving circuit, the GPS receiving circuit receives geographic positioning satellite coordinate signals, after which the geographic positioning satellite coordinate signals are matched with an internal prestored geographic data base to obtain the position of the object, whereupon the position is transmitted to the microprocessor;
whereby the microprocessor obtains the position of the object from the GPS receiving circuit, and obtains information on the circumstances regarding the object being hit by bullets and gunshot sounds from the detectors on the object, whereupon the information is transmitted to a remote server using the signal transmission circuit, at which time, the remote server records the gunshot sounds, and then calculates the location of the gunfire from the gunshot sounds, whereupon relevant authorities are notified of the position of the object, circumstances regarding the object being hit by bullets and location of the gunshot sounds, thereby speeding up emergency aid to personnel and rescue of casualties.

2. The GPS gunfire detection system according to claim 1, wherein the object is a bus, an army vehicle, a police vehicle or bulletproof clothing.

3. The GPS gunfire detection system according to claim 1, wherein the signal transmission circuit is connected to the signal receiving circuit of the GPS tracker through wired means.

4. The GPS gunfire detection system according to claim 1, wherein the signal transmission circuit is connected to the signal receiving circuit of the GPS tracker through wireless means.

5. The GPS gunfire detection system according to claim 1, wherein a battery is located within the object, and the battery is connected to the detectors, thereby enabling electric power to be supplied to the detectors.

6. The GPS gunfire detection system according to claim 5, wherein the battery is a rechargeable battery, which is connected to a solar panel located on the object, thereby enabling electric power converted from solar energy received by the solar panel to charge the battery, thus enabling the battery to maintain a fully charged state and supply electric power to the detectors for long periods of time.

7. The GPS gunfire detection system according to claim 1, wherein the GPS receiving circuit is a GPS (Global Satellite Positioning System), A-GPS (Assisted Global Satellite Positioning System) or GPSone (GPS One, Global Satellite Positioning System One) satellite positioning technology, and the GPS information, including a combination of circumstances related to the object, such as time, position, altitude and speed, along with collected gunshot sounds are transmitted to the remote server.

8. The GPS gunfire detection system according to claim 1, wherein communication media of the signal transmission circuit of the GPS tracker includes various kinds of wireless communication, including:
RF (Radio Frequency), GSM (Global System for Mobile Communications), GPRS (General Packet Radio Services), CDMA (Code Division Multiple Access), WiMAX WiFi (Worldwide Interoperability for Microwave Access Wireless Fidelity) or satellite to satellite communication.

9. The GPS gunfire detection system according to claim 1, wherein a video camera is located on each of the detectors, thus, after the microphones detect gunshot sounds, then the detectors actuate the video cameras to implement video recording, after which the signal transmission circuits transmit the information from recorded video footage to the microprocessor of the GPS tracker, whereupon the microprocessor transmits the information to the remote server using the signal transmission circuit.
